(19) United States
(12) Patent Application Publication
(10) Pub. No.: US 2005/0177383 A1
(43) Pub. Date: Aug. 11, 2005

(54) Merit-based software licensing

(76) Inventors: Xiaofan Lin, San Jose, CA (US); Steven J. Simske, Fort Collins, CO (US); Sherif Yacoub, Mountain View, CA (US); R. John Burns, Half Moon Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/774,321

(22) Filed: Feb. 6, 2004

(51) Int. Cl. G06F 17/60

(52) U.S. Cl. 705/1; 705/8

(57) ABSTRACT

A system and method for merit-based software licensing comprises determining a quality value for a target software based on the target software's performance and computing a licensing fee based on the quality value.

### BACKGROUND

Software licensing is a method by which a software vendor (“licensoer”) is compensated monetarily in exchange for granting the right to use its software to an entity such as a company or an individual (“licensee”). Software licensing generally does not provide a practical and systematic method for determining licensing fees based on the processing quality or relative performance of the software. The lack of merit-based licensing systems is especially significant for certain types of software such as those related to pattern recognition and machine intelligence (“intelligent software”). Examples of intelligent software include software such as optical character recognition software (“OCR”), automatic speech recognition software (“ASR”) and natural language processing software (“NLP”). While substantial technical progress has been made in the development of intelligent software, in many instances such intelligent software is still unable to match the processing accuracy of humans performing the same task. For example, a human operator, albeit much slower than a machine, can “OCR” a typed (or even a hand-written) document much more accurately than an OCR computer program.

The relative performance or processing quality of software has economic implications for software users (licensees). For example, in data entry applications requiring very high levels of accuracy, a large percentage of the total cost to the licensee is spent on post-editing or verification of the data entered into the computer system. As such, a software package with 0.1% error rate substantially reduces the total cost of ownership compared with another software system having, for example, a 1% error rate. Thus, it is reasonable for the high-performing system to charge a premium for licensing the software. Therefore, it is desirable to have a method and system for merit-based software licensing.

### SUMMARY

In accordance with at least one embodiment of the invention, a system and method comprises determining a quality value for target software based on the target software's performance and computing a licensing fee based on the quality value.

### BRIEF DESCRIPTION OF THE DRAWINGS

For a detailed description of various embodiments of the invention, reference will now be made to the following drawing in which:

FIG. 1 is a block diagram illustrating an embodiment of merit-based software licensing in accordance with the teachings of the present invention; and

FIG. 2 depicts a computer system that may be used to determine a quality grade and final licensing cost.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not in function. In the following discussion and in the claims, the terms “including” and “comprising” are used in an open-ended fashion, and thus should be interpreted to mean “including, but not limited to.” Also, the term “couple” or “couples” is intended to mean either an indirect or direct electrical connection. This, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

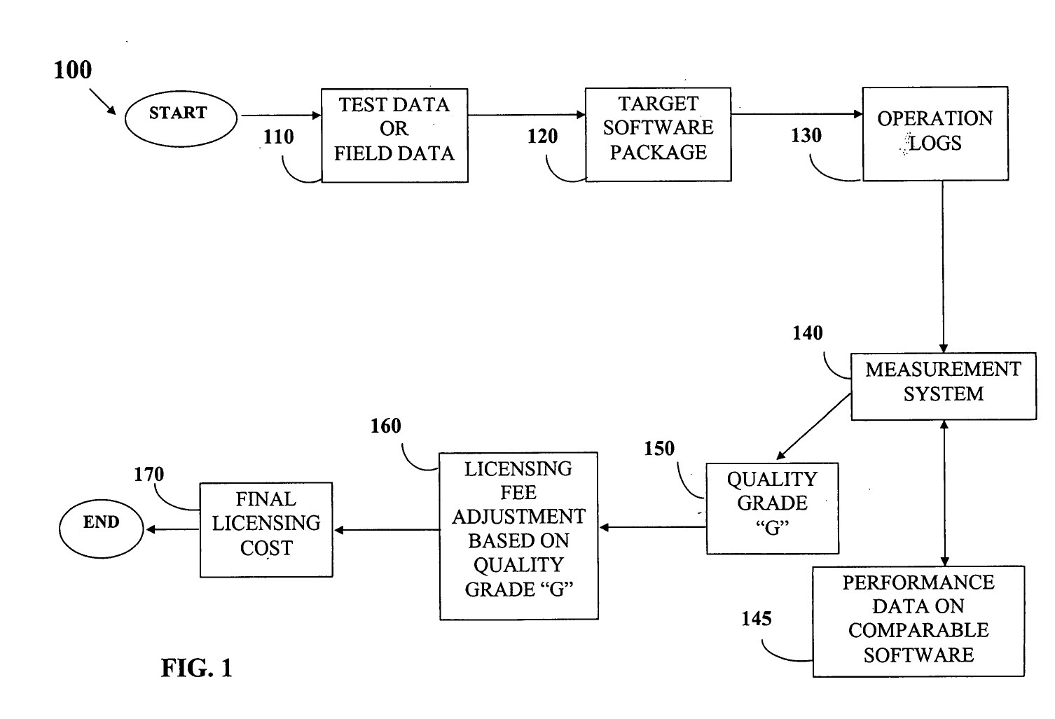

FIG. 1 depicts one exemplary method 100 for merit-based software licensing. Merit-based software licensing method 100 determines a licensing fee for a software package (“the target software”) based on the relative merit of the target software. In general, merit-based software licensing method 100 measures or determines the processing quality of the target software by computing an absolute value or by comparing the performance of the target software to the performance of another software package with functionality similar to that of the target software (“comparable software”). The phrase performance of software is used in its broad sense to include various attributes of the software, including but not limited to accuracy, response time, and throughput. Based on the foregoing analysis, the target software is assigned a quality value, such as a quality grade (“G”). Next, an adjustment is made to a base conventional licensing fee (“B”) (such as a pay-per-copy or pay-per-use fee) of the target software based on the quality grade G. A final licensing cost (“C”) is then determined based on the adjustment of the base licensing fee B in light of the quality grade G. In this manner, the final licensing cost C is a function of the base licensing fee B as adjusted based on the quality grade G (i.e., C=f(B,G)).

The quality grade G and the final licensing cost C may be determined once for the target software. Alternatively, the quality grade G may be determined in different time periods (e.g., different contract periods), such that the final quality-related licensing cost C may be different from one time period to another time period based on the performance of the target software during the relevant time period. The following discussion provides further details relating to merit-based software licensing method 100.

Still referring to FIG. 1, quality grade G 150 of target software 120 may be determined in a quantitative manner. In general, the quality grade G of intelligent software is primarily measured based on the accuracy of the target software 120. However, other factors also may be used in making the quality determination including recognition speed, response time, failure rates, and other features such as the ability to handle multiple or mixed languages in OCR or ASR applications. Thus, various factors may be used in determining the quality of target software 120.

Test data or actual field data 110 is input into target software 120 and the operation of target software 120 is observed. As a result of the execution of target software 120, certain operation logs 130 may be produced. The operation logs 130 contain information about the performance of target software 120 when processing test data 120. The operation logs 130 may be input into a measurement system 140 to determine the quality grade G 150. Measurement system 140 evaluates the performance of target software 120 in comparison to the known performance of other comparable software 145.

Comparable software may be “free engines” that are publicly available. Free engines are usually open source software packages that are generally distributed without any royalty charge or licensing fees. For example, Linux is a popular operating system that is generally available for use without having to pay any licensing fees. In merit-based software licensing method 100, when the comparable software is a free-engine software package, the measurement may be the relative merit of target software 120 (which requires payment of licensing fees) compared with the free engine of comparable software 145. For example, in ASR applications, a method known as Workflow Control Units (“WCU”) may be used to employ a primary engine (“PE”) and a supplemental engine (“SE”) for processing input data. The premise in the WCU scheme is that the PE is a free engine and SE is fee-based engine. In systems employing WCU, the PE first processes the input data. If confidence in the results of PE's processing of the input data is high enough, the results may be directly accepted. Otherwise, the input data may be sent to the SE for further processing. Thus, assuming most of the input data is successfully processed by the PE (which is free), then a substantial reduction in costs may be realized in terms of less licensing fees paid for use of the SE (which is fee-based).

When the comparable software is a free engine and the WCU scheme is employed, the quality grade G 150 of target software 120 (i.e., the fee-based SE) may be computed relative to the quality of comparable software 145 (i.e., the free PE) as follows:
G=(Error rate of SE on input data)/(Error rate of PE on input data passed to SE)
For example, in the above formula, if the SE performs much better than PE on the input data passed to the SE, then quality grade G 150 will be large and the software vendor of SE (i.e., target software 120) may expect a premium in licensing fees.

Various ways exist to measure quality grade G 150. For example, the computation of quality grade G 150 may be performed in a separate testing phase using sample test data instead of live production or field data. Additionally, other techniques for analyzing intelligent software are described in various patents. For example, see: U.S. Pat. No. 6,219,643 entitled, “Method of analyzing dialogs in a natural language speech recognition system;” U.S. Pat. No. 6,405,170 entitled, “Method and system of reviewing the behavior of an interactive speech recognition application;” and U.S. Pat. No. 5,822,401 entitled, “Statistical diagnosis in interactive voice response telephone system.” The foregoing patents are incorporated herein by reference. These patents disclose various techniques for analyzing dialog logs (operation logs) of interactive voice response (“IVR”) applications. The disclosed techniques may be useful in formulating different methods for calculating quality grade G 150.

The value of quality grade G 150 may also be computed as an absolute value as opposed to the relative value discussed in the foregoing paragraphs. In one embodiment of merit-based software licensing method 100, an absolute value for quality grade G 150 may be computed by pre-determining an error rate threshold (“E”) for target software 120. Error rate threshold E may be a negotiated value between the vendor of target software 120 (licensor) and the user of the software (licensee). The value of quality grade G 150 may then be computed as follows: G=(Predetermined error rate threshold E)/(Actual error rate of target software 120).

The above two examples for measuring quality grade G 150 (relative and absolute values) define the value of G in terms of error rates. Error rate is used because, in general, accuracy is an important factor in intelligent software and usually the hardest to improve. However, other factors, such as throughput, multi-lingual capabilities, and Self Reporting of Errors (“SRE”) accuracy, alternatively or additionally may be used in defining the value of quality grade G 150. In the case of SRE, the value of quality grade G 150 may measure the reliability of the confidence values provided by individual software engines. When multiple factors are present, a weighted summation may be adopted for the overall quality grade G 150.

Quality grade G 150 also may be computed using more sophisticated techniques. For example, in interactive voice response (“IVR”) applications, comparative studies can be conducted on the cost-savings of using target software 120. In a call center IVR application environment, the value of quality grade G 150 may be computed as follows: G=(salary cost of call center without use of target software 120)/(salary cost of call center using target software 120).

The above discussions relating to computing quality grade G 150 are based on average measurements over time. However, quality grade G 150 also may be based on a point measurement over a shorter timeframe. In a call center environment, for example, the characteristic customer mix may change over time (e.g., during the course of a day). As a result, the value of quality grade G 150 may vary over the course of the day at different points in time because the changing customer mix changes the nature of field data 110 over the course of the day. In such a situation, the worst short-time quality grade G 150 may be used to perform licensing fee adjustment 160 to determine final licensing cost 170. The foregoing assumes that quality grade G 150 is measured in real time or that there is an accurate predictor available to estimate the quality factor.

Regardless of how quality grade G 150 is computed, the base licensing fee B may be adjusted based on the quality grade G 150. In general, various functions may be utilized to make a licensing fee adjustment 160 in order to compute the final licensing cost C 170. For example, the final licensing cost C 170 may be determined based on the function: C=B+mG. In this example, “B” and “m” are constants that may be negotiated upfront by the two parties. For example, if the software vendor is confident of its technology, the software vendor may agree to a lower “B” value and a higher “m” value. In this manner, the software vendor will assure that most of the final licensing cost C 170 will be decided by quality grade G 150.

Alternatively, a “contract period” model may be used in merit-based software licensing method 100. In one embodiment of a contract period model, during each contract period quality grade G 150 may be measured based on operation logs 130 that are randomly sampled and collected during the period. Alternatively, quality grade G 150 may be measured based on confidential testing data that is kept by a trusted third party. In this manner, different contract periods may have different quality grade G 150 and therefore, different floating final licensing cost C 170. The contract period model may be beneficial in encouraging the software vendor to improve processing quality of target software 120 over time.

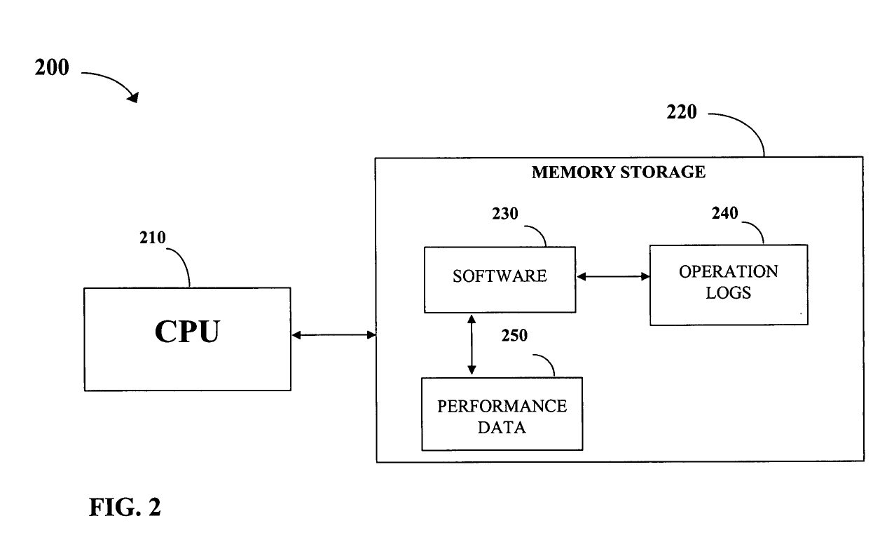

FIG. 2 depicts a computer system 200 which may be used to determine quality grade G 150 and final licensing cost C 170. Computer system 200 comprises a central processing unit (“CPU”) 210 coupled to memory storage 220. Memory storage 220 comprises software 230 for computing quality grade G 150 and final licensing cost C 170 as disclosed above. Memory storage 220 also comprises operation logs 240 and performance data 250. Operation logs 240 contains data relating to operation logs 130 and performance data on comparable software 145. CPU 210 may be programmed with instructions from software 230 to compute quality grade G 150 (as discussed above) with reference to operation logs 240 and performance data 250. CPU 210 also may be programmed with instructions from software 230 to compute final licensing cost C 170 by adjusting base licensing cost B with quality grade G 150 as discussed above.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A processor-based method, comprising:
determining a quality value for a target software based on performance of the target software; and
computing a merit-based licensing fee for the target software based on the quality value.

2. The method of claim 1, wherein determining a quality value for a target software based on the target software's performance comprises comparing the performance of the target software to performance of another software.

3. The method of claim 2, wherein determining a quality value for the target software comprises dividing an error rate associated with the other software by an error rate associated with the target software.

4. The method of claim 2, wherein the other software comprises a free engine.

5. The method of claim 1 further comprising logging the performance of the target software.

6. The method of claim 5, wherein logging the performance of the target software comprises evaluating the target software's performance based on field data.

7. The method of claim 5, wherein logging the performance of the target software comprises evaluating the target software's performance based on test data.

8. The method of claim 1, wherein determining a quality value for a target software based on the target software's performance comprises computing an absolute value for the quality value.

9. The method of claim 8, wherein computing the absolute value comprises dividing a predetermined error rate threshold by an error rate associated with the target software.

10. The method of claim 1, wherein the target software comprises intelligent software.

11. The method of claim 1, wherein determining the quality value comprises determining a quality value based on a factor selected from the group consisting of accuracy level, efficiency level, throughput level, multilingual capability and self-reporting of errors capability of the target software.

12. The method of claim 1, wherein determining the quality value comprises computing a value based on at least one point measurement over a timeframe that is substantially equal to or less than a predetermined time period.

13. The method of claim 1, wherein computing the merit-based licensing fee comprises adjusting a base licensing fee based on the quality value.

14. The method of claim 13, wherein computing the merit-based licensing fee comprises multiplying the quality value by a first constant and adding the result to a second constant.

15. The method of claim 1, wherein computing the merit-based licensing fee comprises a floating final licensing cost.

16. A system, comprising:
a CPU;
a storage device coupled to the CPU and containing executable code; and
wherein, upon executing the code, the processor computes a merit-based licensing fee for a target software based on a quality value associated with the target software.

17. A system as recited in claim 16, further comprising an operation log and wherein the CPU logs performance of the target software in the operation log.

18. A system as recited in claim 16, wherein the CPU compares the performance of the target software to another software.

19. A system as recited in claim 18, wherein the other software comprises a free engine.

20. A system as recited in claim 18, wherein the storage device containing executable code further comprises an algorithm that causes the CPU to determine the quality value for the target software by dividing an error rate associated with the other software by an error rate associated with the target software.

21. A system as recited in claim 16, wherein the storage device containing executable code further comprises an algorithm that causes the CPU to determine the merit-based licensing fee by adjusting a base licensing fee based on the quality value.

22. A storage device containing software that, when executed by a processor, causes the processor to:
store operation logs of a target software;
measure a performance level of the target software based on the operation logs;
determine a quality value for the target software based on the performance level; and
compute a licensing fee for the target software based on the quality value.

23. A storage device as recited in claim 22, wherein determining the quality value comprises comparing the performance of the target software to another software.

24. A storage device as recited in claim 22, wherein computing the licensing fee comprises adjusting a base licensing fee based on the quality value.

25. A system, comprising:
means for measuring a performance level of a target software;
means for determining a quality value for the target software based on the performance level; and
means for computing a licensing fee for the target software based on the quality value.

26. A system as recited in claim 25, wherein determining the quality value comprises comparing performance of the target software to another software.

27. A system as recited in claim 25, wherein computing the licensing fee comprises adjusting a base licensing fee based on the quality value.
